(19) United States
(12) Patent Application Publication
(10) Pub. No.: US 2023/0298459 A1
(43) Pub. Date: Sep. 21, 2023

(54) SYSTEMS AND METHODS FOR A POINT-TO-POINT DRIVER MESSENGER FOR ADVANCED COOPERATIVE SITUATIONAL AWARENESS

(71) Applicant: Honda Motor Co., Ltd., Tokyo (JP)

(72) Inventors: Danyang Tian, Ann Arbor, MI (US); Ehsan Moradi Pari, Ann Arbor, MI (US); Ghayoor Shah, Orlando, FL (US); Shahriar Shahram, Orlando, FL (US); Yaser Pourmohammadi Fallah, Oviedo, FL (US)

(21) Appl. No.: 18/184,446

(22) Filed: Mar. 15, 2023

Related U.S. Application Data
(60) Provisional application No. 63/319,911, filed on Mar. 15, 2022.

(51) Int. Cl. G08G 1/01; G08G 1/16; G08G 1/00

(52) U.S. Cl. CPC G08G 1/0129; G08G 1/164; G08G 1/20; G08G 1/0112

(57) ABSTRACT

A computer device is provided. The computer device includes at least one processor and at least one memory device. The computer device is associated with a host vehicle. The at least one processor is programmed to: receive sensor information from one or more sensors associated with the host vehicle; build a local object map of the surroundings of the host vehicle based upon the received sensor information; identify a driving scenario based on the local object map; identify a target vehicle that will be affected by the identified driving scenario; and transmit one or more messages to the target vehicle about the detected driving scenario.

### CROSS-REFERENCE TO RELATED APPLICATIONS

This patent application claims priority to U.S. Provisional Patent Application Ser. No. 63/319,911, filed Mar. 15, 2022, the entire contents and disclosure of which are hereby incorporated herein by reference in its entirety.

### BACKGROUND

The field of the invention relates generally to controlling connected and autonomous vehicles, and more specifically, to inter-vehicular communication for providing additional information to the controllers of the connected and autonomous vehicles.

Connected and Autonomous Vehicles (CAVs) can utilize vehicular communication and sensor data to create situational awareness and improve driving experiences. While CAVs can rely on data from sensors such as camera and radar for local situational awareness in the vicinity of the Host Vehicle (HV), there can be driving situations desiring a larger local object map encompassing vehicles that are extremely close along with vehicles that may be comparatively distant but still important for scenario-specific situational awareness.

Secondly, there can arise numerous driving conditions where even an elementary level of communication and intention sharing among vehicles would assist in a safer driving experience, something which is not available at all with solely using sensor data.

Furthermore, existing studies and government survey data show that aggressive driving behaviors are prevalent among U.S. drivers, including aggressively switching lanes or cutting in front of another vehicle. As per police data in FARS, around 1.3% of the reported fatal crashes in 2019 were attributed to improper or erratic lane changing. The inability to communicate on road is one of the major factors contributing to selfish driving, road hostility and even road violence. Based on the NHTSA report conducted in 2015, around 95% of the estimated two million vehicle crashes in the U.S from 2005 to 2007 were a consequence of human error, out of which around 35% were due to driver decision error. Given this report along with many others, it is clear that a communication technology assisting drivers in improving their short-term and comparatively long-term driving decisions can greatly assist in reducing the number of road accidents.

### BRIEF DESCRIPTION

In one aspect, a computer device is provided. The computer device includes at least one processor and at least one memory device. The computer device is associated with a host vehicle. The at least one processor is programmed to: receive sensor information from one or more sensors associated with the host vehicle; build a local object map of the surroundings of the host vehicle based upon the received sensor information; identify a driving scenario based on the local object map; identify a target vehicle that will be affected by the identified driving scenario; and/or transmit one or more messages to the target vehicle about the detected driving scenario. The computer device may include additional, less, or alternate actions, including those discussed elsewhere herein.

A computer-implemented method of operating a host vehicle is provided. The method is implemented by a computer device comprising at least one processor and at least one memory device. The method includes receiving sensor information from one or more sensors associated with the host vehicle; building a local object map of the surroundings of the host vehicle based upon the received sensor information; identifying a driving scenario based on the local object map; identifying a target vehicle that will be affected by the identified driving scenario; and/or transmitting one or more messages to the target vehicle about the detected driving scenario. The computer-implemented method may include additional, less, or alternate actions, including those discussed elsewhere herein.

A vehicle is provided. The vehicle includes a vehicle controller comprising at least one processor and at least one memory device. The vehicle controller is programmed to receive sensor information from one or more sensors associated with the vehicle; build a local object map of the surroundings of the vehicle based upon the received sensor information; identify a driving scenario based on the local object map; identify a target vehicle that will be affected by the identified driving scenario; and/or transmit one or more messages to the target vehicle about the detected driving scenario. The vehicle may include additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a block diagram of a lane change scenario, in accordance with at least one embodiment.

FIG. 2 illustrates a block diagram of a system for the Driver Messenger System in accordance with at least one embodiment.

FIG. 3 illustrates a process for performing a lane change scenario shown in FIG. 1 using the Driver Messenger System shown in FIG. 2.

FIG. 4 illustrates a process for identifying a target vehicle shown in FIG. 1 using the target recognition module shown in FIG. 2.

FIG. 5 illustrates determining a lane difference between a host vehicle and a target vehicle both shown in FIG. 1 using lateral difference on a straight roadway.

FIG. 6 illustrates determining a lane difference between a host vehicle and a target vehicle both shown in FIG. 1 using lateral difference on a curved roadway.

FIG. 7 illustrates a schematic diagram of an exemplary vehicle, in accordance with one embodiment of the present disclosure.

FIG. 8 illustrates an exemplary configuration of a user computer device, in accordance with one embodiment of the present disclosure.

FIG. 9 illustrates an exemplary configuration of a server computer device, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

A computer program of one embodiment is embodied on a computer-readable medium. In an example, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

As used herein, the terms “processor” and “computer” and related terms, e.g., “processing device,” “computing device,” and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc—read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

The field of the invention relates generally to controlling connected and autonomous vehicles, and more specifically, to inter-vehicular communication for providing additional information to the controllers of the connected and autonomous vehicles.

Vehicular communication can be used where cooperative vehicles can communicate their safety information in the form of Basic Safety Messages (BSMs). This form of low-latency cooperation can allow vehicles to obtain safety information of both close- and far-range vehicles without relying on the perfect functionality of sensors at all times. Two examples of two main communication technologies are Dedicated Short-Range Communication (DSRC) and Cellular Vehicle-to-Everything (C-V2X). These communication technologies can be used in a plethora of different driving scenarios and traffic densities.

The systems and methods described herein design and implement a point-to-point Driver Messenger System (DMS) that aims to facilitate vehicles in avoiding risky driving situations. The system uses Basic Safety Messages received from nearby vehicles to update the local object map of the host vehicle. The updated map is then used by Driver Messenger System to automatically identify one or more of the pre-defined traffic scenarios. After automatic scenario detection, the final step for Driver Messenger System is to identify potential Target Vehicle(s) (TV) that can benefit from the scenario-specific information pertaining to the host vehicle, and then send the corresponding personalized Driver Intent Message (DIM) to the target vehicles. Personalized messages based on vehicle connectivity can be used to connect drivers and avoid potential on-road misunderstandings and conflicts, therefore potentially directly or indirectly improve on-road safety.

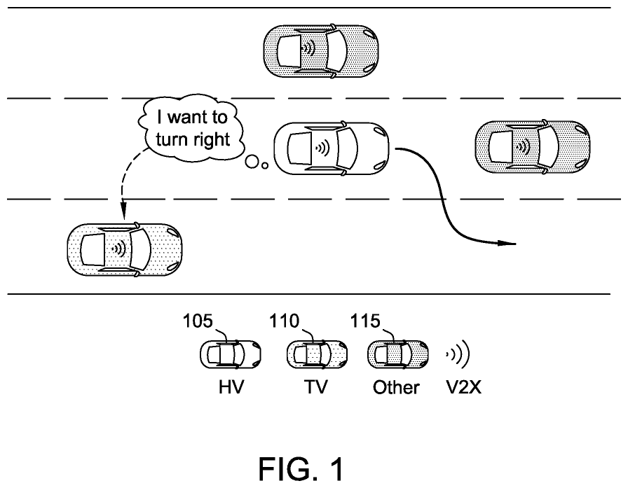

FIG. 1 illustrates a block diagram of a lane change scenario 100, in accordance with at least one embodiment. FIG. 1 represents the Driver Messenger System (DMS) process in the typical lane change scenario 100. A lane change scenario within DMS can be described as the situation where a host vehicle (HV) 105 intends to change its lane from its current lane 120 to an adjacent target lane 125. In the lane change scenario 100, the host vehicle (HV) 105 is in its current lane 120 and surrounded by one or more adjacent lanes 125. The scenario also includes at least one target vehicle (TV) 110 and other vehicles 115. The target vehicle 110 is any vehicle on the roadway that can benefit from communication from the host vehicle 105 about the host vehicle's intentions.

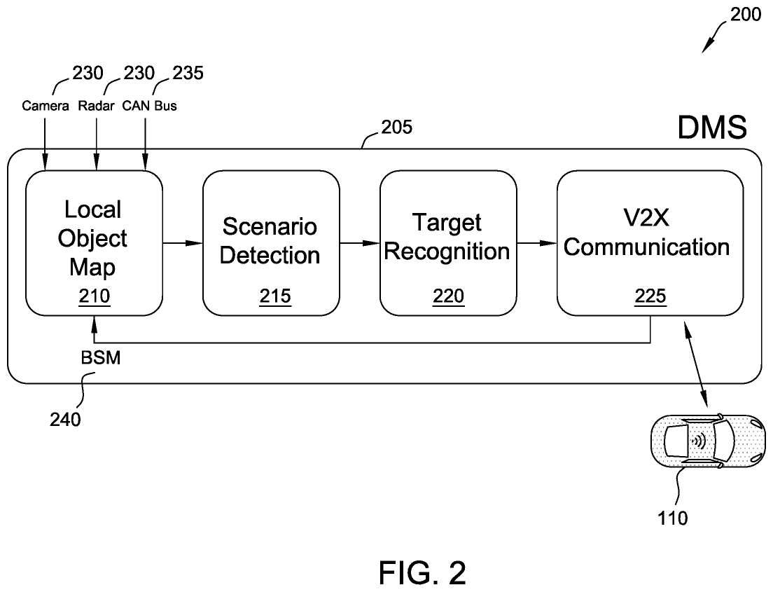

The lane change scenario 100 within the Driver Messenger System (DMS) 205 (shown in FIG. 2) can be described as the situation where a host vehicle (HV) 105 intends to change its lane from its current lane 120 to an adjacent target lane 125. DMS scenario detection module 215 (shown in FIG. 2) for the lane change scenario 100 is triggered as soon as the lane detection information from the local object map module 210 indicates that the host vehicle 105 is within a lane 120 and the turn signal data within the CAN (Controller Area Network) bus information from host vehicle 105 indicates that the host vehicle 105 intends to change its lane.

FIG. 2 illustrates a block diagram of a system 200 for the Driver Messenger System 205 in accordance with at least one embodiment. The high-level framework of the Driver Messenger System 205 in FIG. 2 is from the perspective of the host vehicle 105 (shown in FIG. 1). The Driver Messenger System 205 is designed to communicate with the potential target vehicles 110 regarding the HV's upcoming scenario-specific intentions and therefore, reduce the number of human error-based crashes. The Driver Messenger System (DMS) 205 is designed to utilize the continuously updating a local object map module 210 containing basic safety information of the nearby vehicles and use it to automatically identify one or more of the pre-defined common driver-to-driver communication scenarios. Once the scenario is detected, Driver Messenger System 205 then identifies potential target vehicles 110 and sends a Driver Intent Messages (DIM) to the target vehicle 110 to inform the target vehicle 110 about the host vehicle's intention.

As shown in FIG. 2, the Driver Messenger System 205 is essentially divided into four main components: a local object map module 210, automatic scenario detection module 215, target recognition module 220, and Vehicle-to-Everything (V2X) communications 225, as detailed below.

The local object map module 210 is the initial component of the Driver Messenger System 205 within a host vehicle 105. The local object map module 210 receives data from sensors 230, local CAN Bus 235, and Vehicle-to-Everything communications 225 information as input and forms a map that contains information of the nearby vehicles and the road layout. The sensor information 230 comprises primarily of front and back radars and cameras. Aside from sensor data 230, Driver Messenger System 205 uses Vehicle-to-Everything communications 225 as well to acquire basic safety information from nearby V2X-enabled vehicles. Once the Driver Messenger System 205 within the host vehicle receives all the required information, the local object map module 210 creates a map by fusing all the received information. The resulting information is where the host vehicle 105 can gain access to a collective information of its surroundings and thus possess a better situational awareness for all its future actions. This map would be subject to updating as soon as new sensor and/or basic safety message 240 information from any nearby vehicle is available.

In the exemplary embodiment, the system 200 assumes that all participating vehicles are connected. In some embodiments, the local object map module 210 is created and updated by basic safety message 240 information received from the nearby vehicles.

The scenario detection module 215 is an essential component of the Driver Messenger System 205 since it is responsible for using the local object map module 210 and the host vehicle's own data from the CAN bus 235 to determine whether the host vehicle 105 is in one of the pre-defined traffic scenarios at any given time. Some of the common driving scenarios that have been identified within Driver Messenger System 205 may be, but are not limited to, a) Lane Change; b) Ambiguous Right-of-Way at Stop-Sign Intersections; c) Slow Traffic Ahead; d) Tailgating; e) Late Start at a Green Light; and f) Curved Roads. While the focus described herein is on the lane change scenario 100, one having skill in the art would understand that these other scenarios would also apply to the system 200 described herein.

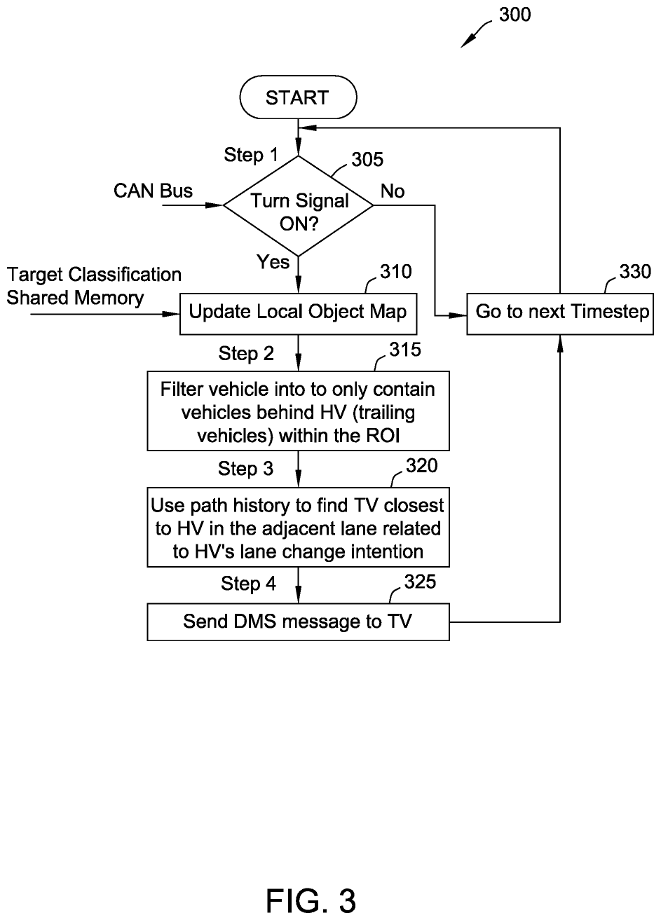

A lane change scenario within the Driver Messenger System 205 can be described as the situation where the host vehicle 105 intends to change its lane from its current lane 120 to an adjacent target lane 125. The Driver Messenger System 205 scenario detection module 215 for the lane change scenario 100 is triggered as soon as the lane detection information from the local object map module 210 indicates that the host vehicle 105 is within a lane 120 and the turn signal data within the CAN bus information 235 from host vehicle 105 indicates that the host vehicle 105 intends to change its lane. Process 300 shown in FIG. 3 illustrates a lane change scenario 100.

Once the Driver Messenger System 205 goes past the scenario detection module 215 and identifies a scenario from the set of configured DMS scenarios, the next main objective is to identify the potential target vehicle(s) for the scenario 100 in consideration. This step allows the Driver Messenger System 205 to serve as an advanced safety feature and inform nearby relevant vehicles of the host vehicle's intentions in particular scenarios.

Once invoked, the target recognition module 220 executes an algorithm to analyze the entire local object map module 210. Based on the host vehicle's current heading, the target recognition module 220 identifies the leading and trailing vehicles up to a target vehicle distance threshold (TV_{distthresh}) from the host vehicle 105. TV_{distthresh} is a configurable parameter for lane change with the Driver Messenger System 205 and this parameter determines how far the Driver Messenger System 205 can be used to send Driver Intent Messages to target vehicles 110. The target vehicle distance threshold varies according to the scenario under consideration. The target recognition module 220 may use coordinate transformation and/or the longitudinal distance between the vehicles. Once the vehicles within TV_{distthresh} have been classified as trailing vehicles in Step 315, the Driver Messenger System 205 determines if one of the trailing vehicles can be classified as the target vehicle 110. The manner in which the information of leading and trailing vehicles is utilized is dependent on the DMS scenario under consideration.

For lane change scenario, once the vehicles have been classified as leading or trailing vehicles, the main objective is to determine if one or more of the trailing vehicles can be termed as the target vehicles 110. This can be done by utilizing longitudinal distance along with host vehicle's path history as explained in the subsection below. In some embodiments, the target vehicle can be termed as the trailing vehicle that is the closest vehicle to the host in the adjacent lane 125 that is the target of the host vehicle's lane change intention. This is the vehicle that would benefit the most as a result of receiving a Driver Intent Message (DIM) from the host vehicle 105 where the host vehicle 105 can inform the target vehicle of its intent to change its lane.

In at least one embodiments, a target vehicle 110 is chosen based on lateral distance between the host vehicle's and a trailing vehicle's current locations, which can be a viable TV recognition method for lane change scenario in the cases where the road topology can be characterized as straight road. However, in the cases of curved roads, this can yield false readings. To counter this, the target recognition module 220 utilizes the notion of host vehicle's path history. The target recognition module 220 can accurately identify which trailing vehicles are adjacent to the host vehicle 105 and thus qualify as a potential target vehicle 110. At every timestep, the Driver Messenger System 205 stores the location information pertaining to the host vehicle 105.

In the case of DMS lane change scenario 100 when the host vehicle 105 needs to recognize one of the trailing vehicles as a target vehicle 110, the target recognition module 220 iterates through its host vehicle's path history and chooses the closest host vehicle 105 history point (CIₕᵢₛₜ) to target vehicle's location. After finding the CIₕᵢₛₜ, the target recognition module 220 calculates the initial lateral distance between CIₕᵢₛₜ and the trailing vehicle's current location. The initial lateral distance is especially useful because it allows the target recognition module 220 to determine lane difference between the trailing vehicle 110 in consideration and host vehicle 105 when the host vehicle 105 was exactly at CIₕᵢₛₜ in the most-recent past. In some embodiments, the local object map updating is performed every 100 ms due to high basic safety message frequency. The lateral distance calculation between CIₕᵢₛₜ and the trailing vehicle 110 would yield accurate initial lane difference.

In addition to initial lateral distance between (CIₕᵢₛₜ) and trailing vehicle 110, the target recognition module 220 considers the history points between CIₕᵢₛₜ and the host vehicle's current location to determine if the host vehicle 105 ever performed a lane change in the past between those history points, as this can impact the final lane difference between host vehicle's and trailing vehicle's current locations. After finding lateral distance between CIₕᵢₛₜ and a trailing vehicle, the target recognition module 220 iterates through the history points from CIₕᵢₛₜ to the host vehicle's current location and uses the host vehicle's yaw rates on the history points to determine if there was any lane change by the host vehicle 105 that should be taken into account. This step mainly includes considering the history points and detecting prolonged irregularities in yaw rate values to suggest a lane change. This way, the Driver Messenger System 205 can detect target vehicles 110 in both of the cases of straight and curved roads.

Finally, the host vehicle 105 can also take turns on a curved road. In these embodiments, the target recognition module 220 uses the (CIₕᵢₛₜ) to detect a target vehicle 110. If the host vehicle 105 switches its lane after that, it may result in a false target vehicle 110 recognition. Therefore, in addition to choosing the (CIₕᵢₛₜ) to the target vehicle 110, the target recognition module 220 iterates through the history points from the chosen (CIₕᵢₛₜ) to the current host vehicle 105 location to determine if there was any lane change by the host vehicle 105 that should be taken into account. The target recognition module 220 does this by using the differential yaw rates of the cluster of chosen points.

The final module in the Driver Messenger System 205 is the V2X communication module 225. The V2X communication module 225 in the Driver Messenger System 205 is responsible for multiple important tasks. First, the V2X communication module 225 transmits and receives basic safety message 240 information to and from nearby vehicles for situational awareness. This information is utilized in the updating of the local object map module 210. The V2X communication module 225 also sends and receives Driver Intent Messages for DMS scenarios. In the case where the host vehicle 105 is in a lane change scenario 100, the target recognition module 220 instructs the V2X communication module 225 to send one or more Driver Intent Messages to the identified target vehicle 110. Similarly, for cases where a vehicle is designated as the target vehicle 110, the Driver Intent Message is received from the host vehicle 105 and is encoded to allow for scenario-specific message content.

FIG. 3 illustrates a process 300 for performing a lane change scenario (shown in FIG. 1) using the Driver Messenger System 205 (shown in FIG. 2). In the exemplary embodiment, the steps of process 300 are performed by the Driver Messenger System 205 from the point of view of the host vehicle 105 (shown in FIG. 1).

Lane change process 300 is divided into four main steps for the Driver Messenger System 205 framework described earlier. Step 305 involves receiving the updated local object map. Step 310 includes the scenario detection block where the Driver Messenger System 205 detects the host vehicle's lane change intent from the local object map, and if so, it leads to the triggering of target vehicle recognition module 220 which constitutes Step 315. If a relevant target vehicle 110 is found, the V2X communication block 225 is invoked as Step 320 where the Driver Messenger System 205 within the host vehicle 105 sends a Driver Intent Message to the target vehicle 110.

In the exemplary embodiment, the Driver Messenger System 205 receives information from the CAN bus 235. Based on the information from the CAN bus 235, the Driver Messenger System 205 determines 305 if the turn signal of host vehicle 105 is on. If the turn signal is not on, then the Driver Messenger System 205 waits 340 for the next time stamp or time period. If the turn signal is on, then the Driver Messenger System 205 updates 310 the local object map module 210 (shown in FIG. 2). The Driver Messenger System 205 filters 315 vehicle information about other vehicles 115 (shown in FIG. 1) to only include those vehicles behind the host vehicle 105. Then the Driver Messenger System 205 uses the path history of the host vehicle 105 to determine the target vehicle 110 (shown in FIG. 1) closest to the host vehicle 105 in the adjacent lane 125 (shown in FIG. 1) related to the host vehicle's lane change. The Driver Messenger System 205 transmits 325 one or more messages to the target vehicle 110. The messages can include, but are not limited to, basic safety messages 240 and/or Driver Intent Messages. In at least one embodiment, the messages inform the target vehicle 110 that the host vehicle 105 is intending to move into the target vehicle's lane.

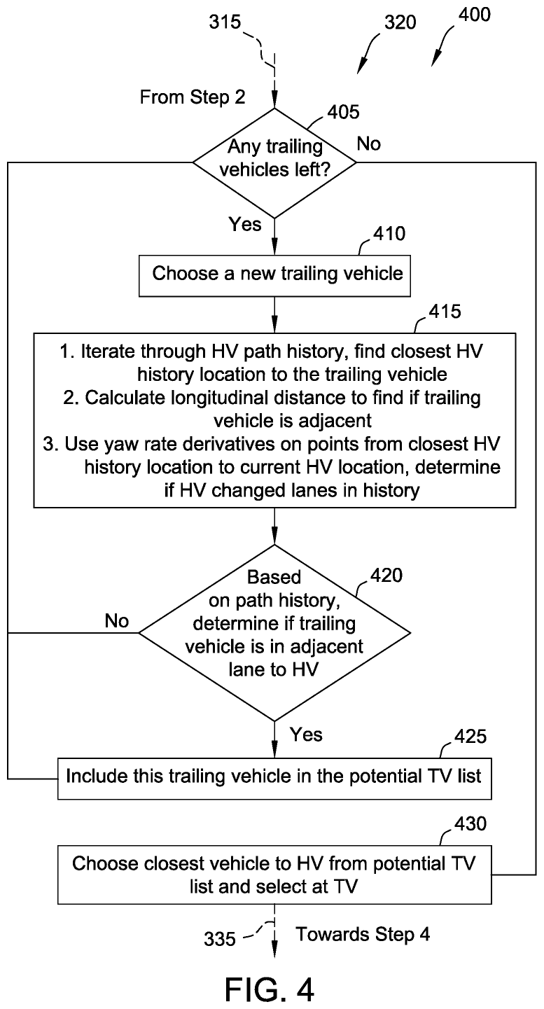

FIG. 4 illustrates a process 400 for identifying a target vehicle 110 (shown in FIG. 1) using the target recognition module 220 (shown in FIG. 2). In the exemplary embodiment, the steps of process 400 are performed by the target recognition module 220 from the point of view of the host vehicle 105 (shown in FIG. 1). In the exemplary embodiment, process 400 is performed as step 320 in process 300.

The flowchart in FIG. 4 illustrates step 320 to consider all trailing vehicles and uses the notion of host vehicle's path history to determine if any of the trailing vehicles can qualify as a potential target vehicle 110. The target vehicle 110 can be formally termed as the trailing vehicle closest to the host vehicle in the adjacent lane 125 (shown in FIG. 1) that is the target of the host vehicle's lane change intention. This is the vehicle that would benefit the most as a result of receiving a Driver Intent Message from the host vehicle 105 where the host vehicle 105 can inform the target vehicle 110 of its intent to change its lane. The notion of host vehicle's path history and the logic behind its usage in target vehicle recognition is further explained below.

In the exemplary embodiment, the target recognition module 220 determines 405 if there are any trailing vehicles that have not been analyzed. If there are still at least one unanalyzed trailing vehicle, the target recognition module 220 chooses 410 a new vehicle to analyze. The target recognition module 220 iterates 415 through the host vehicle's path history to find the closest point in the host vehicle 105 history of locations to the current location of the trailing vehicle. The target recognition module 220 calculates 410 a longitudinal distance to determine if the trailing vehicle is in an adjacent lane 125 (shown in FIG. 1). The target recognition module 220 uses yaw rate derivatives on points from the closest point in the host vehicle 105 history of locations to the current location of the host vehicle 105 to determine if the host vehicle 105 changed lanes in its history. Based on the path history, the target recognition module 220 determines 420 if the trailing vehicle is in an adjacent lane 125 to the current lane 120 of the host vehicle 105.

If the trailing vehicle is not in an adjacent lane 125, then the target recognition module 220 returns to step 405 to start analyzing the next trailing vehicle. If the trailing vehicle is in an adjacent lane 125, the target recognition module 220 includes 425 the trailing vehicle in the potential trailing vehicle list and returns to step 405. If there are no more vehicles to analyze, the target recognition module 220 chooses 420 the closest vehicle to the host vehicle 105 from the potential target vehicle 110 list and selects as the trailing vehicle. The target recognition module 220 returns the target vehicle 110 and the Driver Messenger System 205 proceeds to step 325 in process 300.

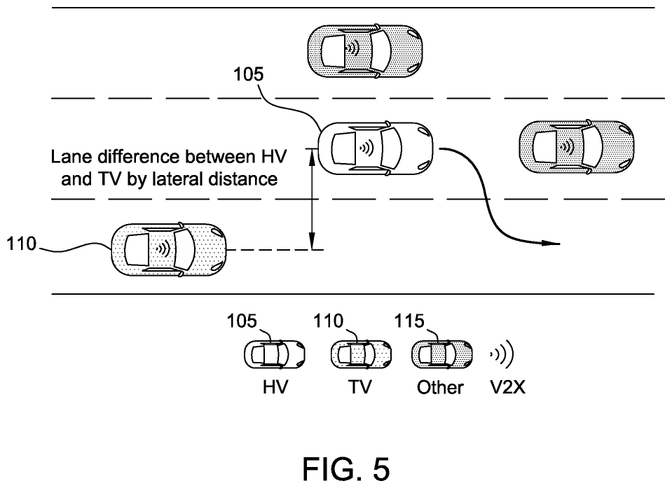

FIG. 5 illustrates determining a lane difference between a host vehicle 105 and a target vehicle 110 (both shown in FIG. 1) using lateral difference on a straight roadway.

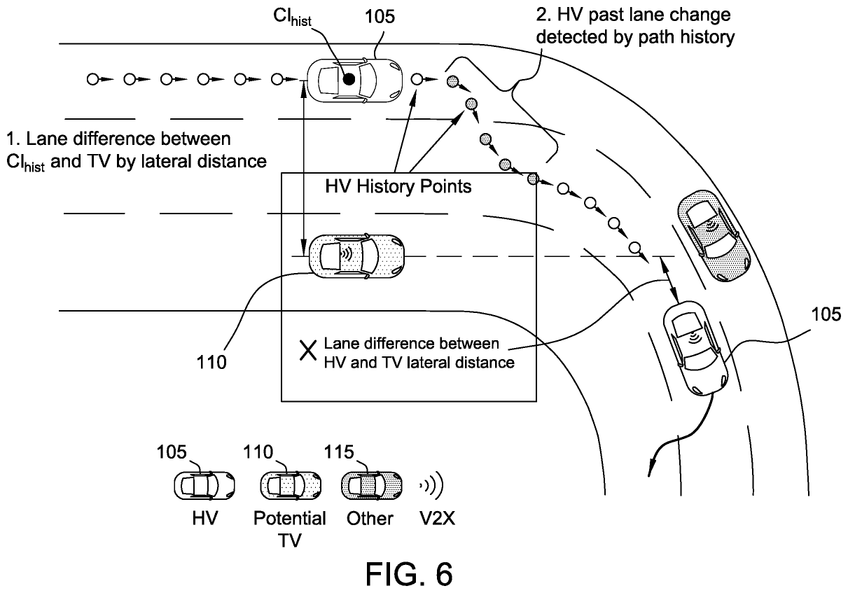

FIG. 6 illustrates determining a lane difference between a host vehicle 105 and a target vehicle 110 (both shown in FIG. 1) using lateral difference on a curved roadway. CIₕᵢₛₜ represents historical locations of the host vehicle 105.

As explained in detail above, one of the contributions of the Driver Messenger System 205 in the lane change scenario is that it can allow the target vehicle 110 to receive advanced information regarding the host vehicle's upcoming lane change in front of it, and thus, allow the target vehicle 110 enough time to react to it and reduce any chance of a near-collision situation with the host vehicle. In some situations, this reaction by the target vehicle 110 is translated into a manual braking maneuver performed by the target vehicle 110 once it receives a Driver Intent Message from the host vehicle 105 regarding the latter's intention of lane change. At the same time as the TV presses brakes in response to DMS message, the HV performs a lane change maneuver. This allows an increase in the inter-vehicular distance between the host vehicle 105 and the target vehicle 110 which translates to an increase in time and space heading.

In addition to the benefits of using path history, the Driver Messenger System 205 is capable of providing advanced safety. Therefore, in line with the reaction model for the host vehicle 105 and the target vehicle 110 in response to a lane change scenario with or without the Driver Messenger System 205, two metrics can be used to show the impact of the Driver Messenger System 205: Time and Space Headway. Time headway is defined as the time difference between the host vehicle 105 and the target vehicle when they are in the same lane after host vehicle 105 changes its lane. On the other hand, space headway is defined as the longitudinal distance between the host vehicle 105 and the target vehicle 110 when they are in the same lane after the host vehicle 105 changes its lane.

This can be understood by the reaction model where the Driver Messenger System 205 allows target vehicles 110 to receive Driver Intent Messages from the host vehicle 105, thereby allowing them to brake and hence, increase the heading numbers, as opposed to scenarios without the Driver Messenger System 205, which solely rely on the car following model. The space heading difference for all TV_{distthresh} values can be consistently higher for the Driver Messenger System 205 scenarios specially at distances within 100 m since that is where braking can result in a bigger difference in headway values and reduce near-collision situations. Similarly, time headway values in the Driver Messenger System 205 scenarios allow for an increase in time due to braking maneuver which can prove to be very beneficial specially in low-distance situations between the host vehicle 105 and the target vehicle 110 since the distance and relative speed between the host vehicle 105 and the target vehicle 110 may not be small enough to force the operation of car following model but it can nevertheless be sufficient enough to take an advanced safety action of braking and increase the distance between the target vehicle 110 and the incoming host vehicle 110.

In other embodiments, there may be both connected and non-connected vehicles in the vicinity of the host vehicle 105 as well. In such cases, it becomes essential to utilize sensors such as camera and radar in conjunction with basic safety messages for vehicle localization and accurate local object map creation. Sensor usage can also become significant in the cases of a congested network causing basic safety message collisions. Accordingly, the host vehicle 105 may have to utilize sensors. Furthermore, a Human-Machine Interface (HMI) may be provided where the proposed the Driver Messenger System 205 can be embedded on an On-Board Unit and the system can be accessed using a test vehicle's dashboard tablet. This can serve to test the Driver Messenger System 205 for end-to-end capability.

The Driver Messenger System 205 works by using basic safety messages from nearby vehicles to update the vehicle's local object map. This map is then used to identify potential target vehicles 110 in the adjacent lane 125 corresponding to the host vehicle's turn signal direction. Once the target vehicle has been identified, the Driver Messenger System 205 within the host vehicle 105 sends a point-to-point Driver Intent Message to the target vehicle 110 regarding host vehicle's upcoming lane change intention. Lane changes can occur on different kinds of road segments such as straight or curved road, thus the Driver Messenger System 205 provides a method where host vehicle history locations are used to find an accurate relation between the target vehicle 110 and the host vehicle 105, especially when the target vehicle 110 is far from the host vehicle 105.

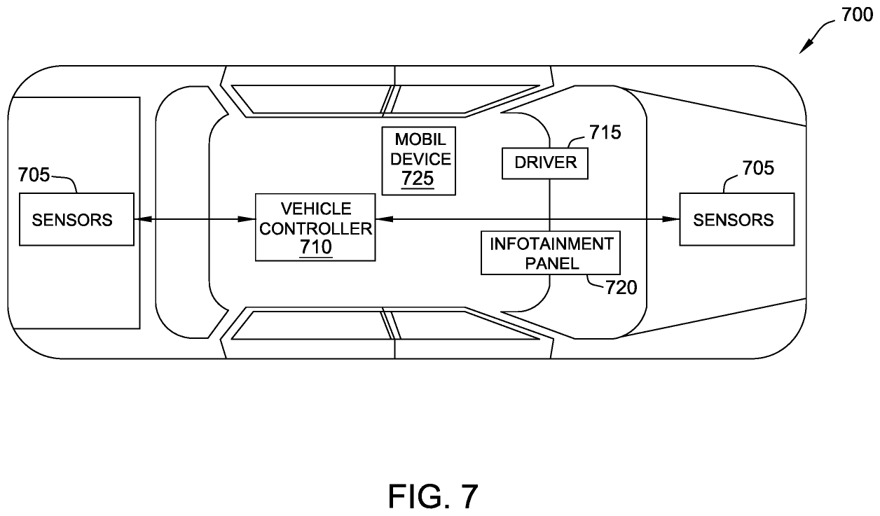

FIG. 7 depicts a view of an exemplary vehicle 700. In some embodiments, vehicle 700 may be an autonomous or semi-autonomous vehicle capable of fulfilling the transportation capabilities of a traditional automobile or other vehicle. In these embodiments, vehicle 700 may be capable of sensing its environment and navigating without human input. In other embodiments, vehicle 700 is a manual vehicle or a semi-autonomous vehicle with driver assistance systems, such as, but not limited to, lane keep assistance and parallel parking assistance, where the vehicle may be as a traditional automobile that is controlled by a driver 715.

Vehicle 700 may include a plurality of sensors 705 and a vehicle controller 710. In some embodiments, the Driver Messenger System 205 is a part of or in communication with the vehicle controller 710. The plurality of sensors 705 may detect the current surroundings and location of vehicle 700. Plurality of sensors 705 may include, but are not limited to, radar, LIDAR, proximity sensors, ultrasonic sensors, electromagnetic sensors, wide RADAR, long distance RADAR, Global Positioning System (GPS), video devices, imaging devices, cameras, audio recorders, inertial measurement unit, and computer vision. Plurality of sensors 705 may also include sensors that detect conditions of vehicle 700, such as speed, acceleration, gear, braking, and other conditions related to the operation of vehicle 700, for example: at least one of a measurement of at least one of speed, direction rate of acceleration, rate of deceleration, location, position, orientation, and rotation of the vehicle, and a measurement of one or more changes to at least one of speed, direction rate of acceleration, rate of deceleration, location, position, orientation, and rotation of the vehicle. Furthermore, plurality of sensors 705 may include impact sensors that detect impacts to vehicle 700, including force and direction and sensors that detect actions of vehicle 700, such the deployment of airbags. In some embodiments, plurality of sensors 705 may detect the presence of driver 715 and one or more passengers (not shown) in vehicle 700. In these embodiments, plurality of sensors 705 may detect the presence of fastened seatbelts, the weight in each seat in vehicle 700, heat signatures, or any other method of detecting information about driver 715 and/or passengers in vehicle 700.

In the exemplary embodiment, the plurality of sensors 705 include a back-up camera for viewing behind the vehicle 700. The back-up camera can be used to assist the driver 715 with visibility when backing the vehicle 700 up. The back-up camera can also be used by the vehicle controller 710 while autonomously or semi-autonomously driving the vehicle. In some embodiments, the output of the back-up camera can be displayed in an infotainment panel 720 on the dashboard of the vehicle 700.

In one example, plurality of sensors 705 may include LIDAR, radar, weight sensors, accelerometer, gyroscope, compass and/or other types of sensors to identify the orientation and profile of the vehicle 700. Vehicle controller 710 and/or another computing device(s) (e.g., mobile device(s)) may be configured to monitor sensor data from plurality of sensors 705 and/or other sensors to assist in operation of the vehicle 700. Vehicle controller 710 may interpret the sensory information to identify appropriate navigation paths, detect threats, and react to conditions. In some embodiments, vehicle controller 710 may be able to communicate with the driver 715 and/or others in the vehicle 700 through the infotainment panel 720 and/or one or more remote computer devices, such as mobile device 725. In the example embodiment, mobile device 725 is associated with driver 715 and includes one or more internal sensors, such as an accelerometer, a gyroscope, and/or a compass. Mobile device 725 may be capable of communicating with vehicle controller 710 wirelessly. In addition, vehicle controller 710 and mobile device 725 may be configured to communicate with computer devices located remotely from vehicle 700.

In some embodiments, vehicle 700 may include autonomous or semi-autonomous vehicle-related functionality or technology that may be used with the present embodiments to replace human driver actions may include and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (l) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; (t) autonomous or semi-autonomous lane keeping assistance; and/or other functionality. In these embodiments, the autonomous or semi-autonomous vehicle-related functionality or technology may be controlled, operated, and/or in communication with vehicle controller 710.

The wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally or alternatively, the autonomous or semi-autonomous technology or functionality may include and/or be related to: driver alertness or responsive monitoring; pedestrian detection; artificial intelligence and/or back-up systems; hazard avoidance; navigation or GPS -related systems; security and/or anti-hacking measures; lane keeping assistance; and/or theft prevention systems.

While vehicle 700 may be an automobile in the exemplary embodiment, in other embodiments, vehicle 700 may be, but is not limited to, other types of ground craft, aircraft, watercraft, and spacecraft vehicles.

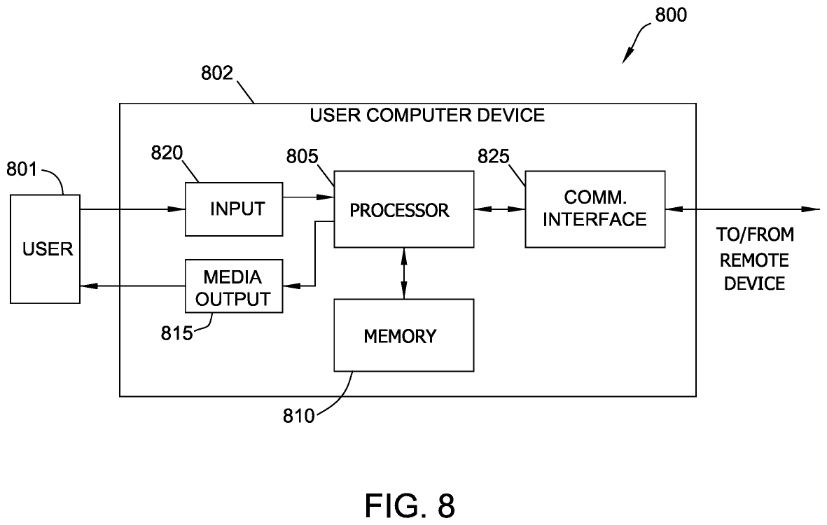

FIG. 8 depicts an exemplary configuration 800 of user computer device 802, in accordance with one embodiment of the present disclosure. In the exemplary embodiment, user computer device 802 may be similar to, or the same as, and Driver Messenger System 205 (shown in FIG. 2). User computer device 802 may be operated by a user 801. User computer device 802 may include, but is not limited to, vehicle controller 710 (shown in FIG. 7) and the Driver Messenger System 205. User computer device 802 may include a processor 805 for executing instructions. In some embodiments, executable instructions may be stored in a memory device 810. Processor 805 may include one or more processing units (e.g., in a multi-core configuration). Memory device 810 may be any device allowing information such as executable instructions and/or repair data to be stored and retrieved. Memory device 810 may include one or more computer readable media.

User computer device 802 may also include at least one media output component 815 for presenting information to user 801. Media output component 815 may be any component capable of conveying information to user 801. In some embodiments, media output component 815 may include an output adapter (not shown) such as a video adapter and/or an audio adapter. An output adapter may be operatively coupled to processor 805 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 815 may be configured to present a graphical user interface (e.g., a web browser and/or a client application) to user 801. A graphical user interface may include, for example, an interface for viewing following distance information. In some embodiments, user computer device 802 may include an input device 820 for receiving input from user 801. User 801 may use input device 820 to, without limitation, acknowledge receiving basic safety message information.

Input device 820 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 815 and input device 820.

User computer device 802 may also include a communication interface 825, communicatively coupled to a remote device such as Driver Messenger System 205. Communication interface 825 may include, for example, a wired or wireless network adapter and/or a wireless data transceiver for use with a mobile telecommunications network.

Stored in memory device 810 are, for example, computer readable instructions for providing a user interface to user 801 via media output component 815 and, optionally, receiving and processing input from input device 820. A user interface may include, among other possibilities, a web browser and/or a client application. Web browsers enable users, such as user 801, to display and interact with media and other information typically embedded on a web page or a website from Driver Messenger System 205. A client application may allow user 801 to interact with, for example, Driver Messenger System 205. For example, instructions may be stored by a cloud service, and the output of the execution of the instructions sent to the media output component 815.

In some embodiments, user computer device 802 may include, or be in communication with, one or more sensors, such as sensor 705 (shown in FIG. 7). User computer device 802 may be configured to receive data from the one or more sensors and store the received data in memory device 810. Furthermore, user computer device 802 may be configured to transmit the sensor data to a remote computer device, such as vehicle controller 710 or Driver Messenger System 205, through communication interface 825.

The types of autonomous or semi-autonomous vehicle-related functionality or technology that may be used with the present embodiments to replace human driver actions may include and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (l) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; (t) autonomous or semi-autonomous lane keeping assistance; and/or other functionality.

In the exemplary embodiment, the vehicle 700 includes a plurality of sensors 705 (shown in FIG. 7) and a vehicle controller 710. The vehicle controller 710 includes at least one processor 805 in communication with at least one memory device 810. The vehicle controller 710 collects a plurality of sensor information observed by the plurality of sensors 705 during operation of the vehicle 700. The vehicle controller 710 analyzes the plurality of sensor information to detect target vehicles 110 (shown in FIG. 1).

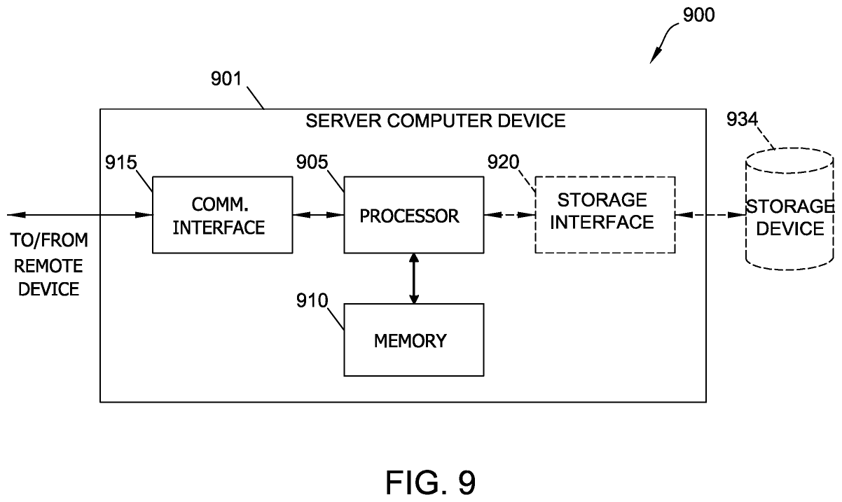

FIG. 9 depicts an exemplary configuration 900 of a server computer device 901, in accordance with one embodiment of the present disclosure. In the exemplary embodiment, server computer device 901 may be similar to, or the same as, Driver Messenger System 205 (shown in FIG. 2). Server computer device 901 may include, but is not limited to, Driver Messenger System 205. Server computer device 901 may also include a processor 905 for executing instructions. Instructions may be stored in a memory area 910. Processor 905 may include one or more processing units (e.g., in a multi-core configuration).

Processor 905 may be operatively coupled to a communication interface 915 such that server computer device 901 is capable of communicating with a remote device such as another server computer device 901, Driver Messenger System 205, vehicle controller 710, and vehicle controllers associated with other vehicles 115 (shown in FIG. 1), (for example, using wireless communication or data transmission over one or more radio links or digital communication channels).

Processor 905 may also be operatively coupled to a storage device 934. Storage device 934 may be any computer-operated hardware suitable for storing and/or retrieving data, such as, but not limited to, data associated with one or more databases . In some embodiments, storage device 934 may be integrated in server computer device 901. For example, server computer device 901 may include one or more hard disk drives as storage device 934.

In other embodiments, storage device 934 may be external to server computer device 901 and may be accessed by a plurality of server computer devices 901. For example, storage device 934 may include a storage area network (SAN), a network attached storage (NAS) system, and/or multiple storage units such as hard disks and/or solid state disks in a redundant array of inexpensive disks (RAID) configuration.

In some embodiments, processor 905 may be operatively coupled to storage device 934 via a storage interface 920. Storage interface 920 may be any component capable of providing processor 905 with access to storage device 934. Storage interface 920 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 905 with access to storage device 934.

Processor 905 may execute computer-executable instructions for implementing aspects of the disclosure. In some embodiments, the processor 905 may be transformed into a special purpose microprocessor by executing computer-executable instructions or by otherwise being programmed. For example, the processor 905 may be programmed with the instruction such as illustrated in FIGS. 3 and 4.

For the methods discussed directly above, the wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally or alternatively, the autonomous or semi-autonomous technology or functionality may include and/or be related to: driver alertness or responsive monitoring; pedestrian detection; artificial intelligence and/or back-up systems; navigation or GPS-related systems; security and/or anti-hacking measures; lane keeping assistance; and/or theft prevention systems.

In the exemplary embodiment, a computer device 205 includes at least one processor 905 and at least one memory device 910. The computer device 205 is associated with a host vehicle 105. The computer device 205 receives sensor information from one or more sensors 705 associated with the host vehicle 105. The computer device 205 builds a local object map of the surroundings of the host vehicle 105 based upon the received sensor information. The computer device 205 identifies a driving scenario based on the local object map. The computer device 205 identifies a target vehicle 110 that will be affected by the identified driving scenario. The computer device 205 transmits one or more messages to the target vehicle 110 about the detected driving scenario.

In some further embodiments, the computer device 205 receives one or more status messages from a first vehicle 115 within a predetermined distance of the host vehicle 105. The computer device 205 updates the local object map of the surroundings of the host vehicle 105 based upon the received on or more status messages.

In additional embodiments, the computer device 205 receives a plurality of status messages from a plurality of vehicles 115 within a predetermined distance of the host vehicle 105. The computer device 205 builds the local object map of the surroundings of the host vehicle 105 based upon the received on or more status messages and the received sensor information.

In some additional embodiments, the computer device 205 detects a plurality of vehicles 115 within a predetermined distance of the host vehicle 105 based upon the local object map. The computer device 205 determines a corresponding distance for each of the plurality of vehicles 115. The computer device 205 identifies the target vehicle 110 based upon the identified driving scenario and the plurality of distances for the plurality of vehicles 115. The computer device 205 categorizes the plurality of vehicles 115 into a subset of trailing vehicles and a subset of leading vehicles.

In at least one embodiment, the computer device 205 stores a plurality of driving scenarios including one or more of Lane Change; Ambiguous Right-of-Way at Stop-Sign Intersections; Slow Traffic Ahead; Tailgating; Late Start at a Green Light; and Curved Roads. The driving scenario is identified from the plurality of driving scenarios.

In another embodiment, the computer device 205 identifies the target vehicle 110 based upon a lateral distance between the host vehicle 105 and the target vehicle 110.

In a further embodiment, the computer device 205 stores a plurality of historical locations for a plurality of vehicles 115. The computer device 205 identifies the target vehicle 110 that will be affected by the identified driving scenario based upon the plurality of historical locations for the plurality of vehicles 115. The computer device 205 identifies the target vehicle 110 based upon a point where the host vehicle 105 was closest to the target vehicle 110 where the host vehicle in on a curved road.

In still further embodiments, the computer device 205 calculates an initial lateral distance between the host vehicle 105 at the point closest to the target vehicle 110 and a current location of the target vehicle 110. The computer device 205 determines if the host vehicle 105 performed a lane change within the plurality of historical locations based upon the host vehicle's yaw rates through the plurality of historical locations.

In still additional embodiments, the computer device 205 determines if the host vehicle 105 performed a lane change within the plurality of historical locations.

In another embodiment, the computer device 205 determines if each potential target vehicle 110 is in a same lane at the host vehicle 105.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on vehicles, stations, nodes, or mobile devices, or associated with smart infrastructures and/or remote servers), and/or through implementation of computer-executable instructions stored on non-transitory computer-readable media or medium. Unless described herein to the contrary, the various steps of the several processes may be performed in a different order, or simultaneously in some instances.

Additionally, the computer systems discussed herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/sub-steps, and store collected data (e.g., driver intent to change lanes, etc.) in a memory or storage associated therewith. This stored information may be used by the respective processing elements to make the determinations necessary to perform other relevant processing steps, as described above.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

The exemplary systems and methods described and illustrated herein therefore significantly increase the safety of operation of autonomous and semi-autonomous vehicles by reducing the potential for damage to the vehicles and the vehicle's surroundings.

The present systems and methods are further advantageous over conventional techniques the embodiments herein are not confined to a single type of vehicle and/or situation but may instead allow for versatile operation within multiple different types of vehicles, including ground craft, watercraft, aircraft, and spacecraft. Accordingly, these novel techniques are of particular value to vehicle manufacturers who desire to have these methods and systems available for the users of their vehicles.

Exemplary embodiments of systems and methods for securely communicating driver intent to other vehicles, are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer device comprising at least one processor and at least one memory device, wherein the computer device is associated with a host vehicle, wherein the at least one processor is programmed to:
receive sensor information from one or more sensors associated with the host vehicle;
build a local object map of the surroundings of the host vehicle based upon the received sensor information;
identify a driving scenario based on the local object map;
identify a target vehicle that will be affected by the identified driving scenario; and
transmit one or more messages to the target vehicle about the detected driving scenario.

2. The computer device of claim 1, wherein the at least one processor is further programmed to receive one or more status messages from a first vehicle within a predetermined distance of the host vehicle.

3. The computer device of claim 2, wherein the at least one processor is further programmed to update the local object map of the surroundings of the host vehicle based upon the received on or more status messages.

4. The computer device of claim 1, wherein the at least one processor is further programmed to:
receive a plurality of status messages from a plurality of vehicles within a predetermined distance of the host vehicle; and
build the local object map of the surroundings of the host vehicle based upon the received on or more status messages and the received sensor information.

5. The computer device of claim 1, wherein the at least one processor is further programmed to:
detect a plurality of vehicles within a predetermined distance of the host vehicle based upon the local object map;
determine a corresponding distance for each of the plurality of vehicles; and
identify the target vehicle based upon the identified driving scenario and the plurality of distances for the plurality of vehicles.

6. The computer device of claim 5, wherein the at least one processor is further programmed to categorize the plurality of vehicles into a subset of trailing vehicles and a subset of leading vehicles.

7. The computer device of claim 1, wherein the at least one processor is further programmed to store a plurality of driving scenarios including one or more of Lane Change; Ambiguous Right-of-Way at Stop-Sign Intersections; Slow Traffic Ahead; Tailgating; Late Start at a Green Light; and Curved Roads.

8. The computer device of claim 7, wherein the driving scenario is identified from the plurality of driving scenarios.

9. The computer device of claim 1, wherein the at least one processor is further programmed to identify the target vehicle based upon a lateral distance between the host vehicle and the target vehicle.

10. The computer device of claim 1, wherein the at least one processor is further programmed to:
store a plurality of historical locations for a plurality of vehicles; and
identify the target vehicle that will be affected by the identified driving scenario based upon the plurality of historical locations for the plurality of vehicles.

11. The computer device of claim 10, wherein the host vehicle in on a curved road and the target vehicle is identified based upon a point where the host vehicle was closest to the target vehicle.

12. The computer device of claim 11, wherein the at least one processor is further programmed to calculate an initial lateral distance between the host vehicle at the point closest to the target vehicle and a current location of the target vehicle.

13. The computer device of claim 9, wherein the at least one processor is further programmed to determine if the host vehicle performed a lane change within the plurality of historical locations based upon the host vehicle's yaw rates through the plurality of historical locations.

14. The computer device of claim 9, wherein the at least one processor is further programmed to determine if the host vehicle performed a lane change within the plurality of historical locations.

15. The computer device of claim 1, wherein the at least one processor is further programmed to determine if each potential target vehicle is in a same lane at the host vehicle.

16. A computer-implemented method of operating a host vehicle, the method implemented by a computer device comprising at least one processor and at least one memory device, wherein the method comprises:
receiving sensor information from one or more sensors associated with the host vehicle;
building a local object map of the surroundings of the host vehicle based upon the received sensor information;
identifying a driving scenario based on the local object map;
identifying a target vehicle that will be affected by the identified driving scenario; and
transmitting one or more messages to the target vehicle about the detected driving scenario.

17. A vehicle comprising:
a vehicle controller comprising at least one processor and at least one memory device, wherein the vehicle controller is associated with the vehicle, wherein the vehicle controller is programmed to:
receive sensor information from one or more sensors associated with the vehicle;
build a local object map of the surroundings of the vehicle based upon the received sensor information;
identify a driving scenario based on the local object map;
identify a target vehicle that will be affected by the identified driving scenario; and
transmit one or more messages to the target vehicle about the detected driving scenario.

18. The vehicle of claim 17, wherein the vehicle controller is further programmed to:
receive one or more status messages from a first vehicle within a predetermined distance of the host vehicle; and
update the local object map of the surroundings of the host vehicle based upon the received on or more status messages.

19. The vehicle of claim 17, wherein the vehicle controller is further programmed to:
receive a plurality of status messages from a plurality of vehicles within a predetermined distance of the host vehicle; and
build the local object map of the surroundings of the host vehicle based upon the received on or more status messages and the received sensor information.

20. The vehicle of claim 17, wherein the vehicle controller is further programmed to:
detect a plurality of vehicles within a predetermined distance of the host vehicle based upon the local object map; and
determine a corresponding distance for each of the plurality of vehicles; and
identify the target vehicle based upon the identified driving scenario and the plurality of distances for the plurality of vehicles.
